(19) United States
(12) Patent Application Publication
(10) Pub. No.: US 2005/0137989 A1
(43) Pub. Date: Jun. 23, 2005

(54) Detecting copied value-added indicia

(76) Inventor: George M. Brookner, Norwalk, CT (US)

Correspondence Address: PERMAN & GREEN, 425 POST ROAD, FAIRFIELD, CT, 06824, US

(21) Appl. No.: 10/742,337

(22) Filed: Dec. 19, 2003

(51) Int. Cl. G06F 17/60

(52) U.S. Cl. 705/410

(57) ABSTRACT

A method and apparatus for detecting a value added indicia on a mailpiece. In one embodiment, the method comprises radiating the indicia with a radio frequency to energize the indicia, and receiving information from the radiated indicia. The information including an identifier and a value associated with the mailpiece.

### BACKGROUND OF THE INVENTION

1. Field of the Invention

The present invention is generally related to forming and detecting indicia and in particular to an indicia formed as an electronic circuit on a substrate.

2. Brief Description of Related Developments

There are many applications being developed by numerous vendors that utilize digital signatures to add higher levels of security to information and data. The U.S. Postal Service has sponsored the Information Based Indicia Program (“IBIP”), which uses these digital signatures in a new form of postage evidencing indicia. Since these digital signatures can be used for postage indicia proof of authenticity, they are considered to be equivalent to money. Applications such as ticketing, secure branding and e-commerce transactions can all utilize digital signatures to produce secure indicia for payment evidencing.

In general these digital signatures are generated using a computer, a standard printer and a secure cryptographic module, which securely stores and dispenses money and computes and transmits digital signatures associated with the money transactions performed by the cryptographic device. This digital signature joined to the postage indicia data can then be applied in printed form using a two-dimensional barcode or other means.

Once the indicia with its digital signature is generated and printed, it is then necessary to verify these indicia for user authentication and data integrity, i.e., that the data signed by the crypto-vault has not been altered. This verification is typically the step performed by the merchant or vendor who has promised to provide the goods and/or services to the customer who holds the document that contains the digital signature based indicia. Once the signature is verified, then the merchant can be assured that proper payment has been made for the goods and/or services to be rendered.

With the development of high quality image copying and reproduction systems, there exists a problem where an original printed document can be copied and the copy is not easily distinguishable, if at all, from the original document. This results in the ability of a defrauder to make undistinguishable copies of documents and introduce them as originals. In an environment where there is a value associated with the presentation of an original to a recipient, for value returned, the copying of the original and presenting the same for value returned is fraudulent.

Indicia, such as digitally signed indicia, are commonly used to provide proof of payment. For example, in mail systems, indicia are used to provide evidence that the postage was paid as well as to provide additional information fields. The indicia could include encrypted information, dimensional symbols, or other information of value indicating that a payment was made. Examples of such indicia and indicia generating systems including postal security devices (“PSD”) are described in copending U.S. application Ser. No. 10/309,563, filed on Dec. 24, 2002, U.S. Pat. No. 6,009,417, and copending application Ser. No. 09/711,741, each of which is commonly assigned to the assignee of this application, the disclosures of which are incorporated herein by reference in their entirety.

Postage meters are used to print postage indicium and other indicia of value. A postage indicium must evidence that postage for a given mailpiece has been paid. The postage indicium or other proof of payment indicium can be digitally generated data and the data can be represented as an image on the piece (such as a mailpiece) requiring the proof of payment. The proof of payment can be represented for example, as a graphical image, human readable information, machine readable formats such as various bar codes (both one and two-dimensional), OCR characters, or any combination thereof. In some instances, postal indicia can be printed using a home computer system and printer. A typical postage meter prints its postage by means of an intaglio-type metal or strong plastic printing plate or die plate, using specified fluorescent ink.

Notwithstanding the reliability, low cost, and ease of use of present-day postage meter designs, some postal authorities have suggested that all postage meters presently in use be removed from service and that postage be printed by common computer printers using ordinary ink or a postage meter printing such postage digitally. This means that anyone with an ordinary computer printer can potentially generate a plausible-looking postal indicium at any time and in any desired quantity. One approach for reducing fraud, when ordinary computer printers are used, is to incorporate cryptographically secure information into the postal indicium, and to read and verify that information on each and every mail piece. The cryptographic content of the printed indicia image generally includes information unique to that transaction, including for example in a mail application, the specific postal security device (“PSD”). To be commercially viable, system configurations that generate cryptographically secure information for use in printing postal indicia must not only satisfy the requirements of the postal authorities, but must also provide user functions more or less approximating that of present-day postage meters. Such a system is described in U.S. application Ser. No. 09/711,741, the disclosure of which is incorporated herein by reference in its entirety.

With the development of highly sophisticated printing devices and copying systems, a danger exists that attempts will be made to reproduce or “copy” postal indicia or other indicia for value from a validly printed or produced indicia. Thus, it would be advantageous to have a printing system and methodology that can deliver an image or “indicia” to a substrate that is capable of being scanned and differentiated from what might be considered an “exact” copy of the original image.

Read-only transponders store information that can be electronically “read”. The stored information can be for example, a unique code. In some systems, a signal can be sent to a Radio Frequency Identity or Identification (RFID) tag, which charges the tag and allows the information stored in the tag to be returned.

RFID is a means of storing and retrieving data through electromagnetic transmission to an RF compatible integrated circuit.

RFID systems have several basic components or technical characteristics that define them. Generally, these are a reader, including an antenna (the device that is used to read and/or write data to RFID tags), a tag (a device that transmits to a reader the data) and the communication between them (RFID uses a defined radio frequency and protocol to transmit and receive data from tags).

RFID tags can be segregated into two major classifications active tags and passive tags, as defined by their power source.

Active tags contain both a radio frequency transceiver and battery to power the transceiver. Because there is a transceiver on the tag, active tags have substantially more range (approximately 300 feet or more) than passive or “active/passive tags.” Active tags are also considerably more expensive than passive tags and, as with any battery-powered product, the batteries must be replaced periodically or the life cycle of the tag is within acceptable usage limits.

Passive tags can be either battery or non-battery operated, as determined by the intended application. Passive tags reflect the RF signal transmitted to them from a reader or transceiver and add information by modulating the reflected signal. A passive tag does not use a battery to boost the energy of the reflected signal. A passive tag may use a battery to maintain memory in the tag or power the electronics that enable the tag to modulate the reflected signal. Battery-less (“pure passive” or “beam powered”) tags do not contain an internal power source such as a battery, and are thus easier, and less expensive to manufacture. These purely passive or “reflective” tags rely upon the electromagnetic energy radiated by an interrogator to power the RF integrated circuit that makes up the tag itself.

There is a version of a passive tag that does contain a battery. This type of passive tag with a battery (“active/passive”) has some of the enhanced, and speed attributes of a true active tag, but still communicates in the same method, as do other passive tags. These active/passive tags that do contain an internal power source, usually are much more complex integrated circuits with multiple components.

RF tags can also be distinguished by their memory type. Read/write memory, can be read as well as written into. Its data can be dynamically altered. Read only (typically “chipless”) type of tag memory is factory programmed and cannot be altered after the manufacturing process. Its data is static.

Tags and a reader communicate by wireless signal in a process known as coupling. Two methods of wireless signal distinguish and categorize RFID systems. Close proximity electromagnetic, or inductive coupling systems and propagating electromagnetic waves. Coupling is via antenna structures forming an integral feature in both tags and readers.

Printed sensors and logic circuits are now being built on a variety of new substrates including paper. The article entitled “Investigation of paper based RFID with integrated sensors” by Jan Lundgren (2001), the disclosure of which is incorporated herein by reference in its entirety, describes developments related to printing the entire RFID tag system onto paper.

### SUMMARY OF THE INVENTION

The present invention is directed to detecting a value added indicia on a mailpiece. In one embodiment, the method comprises radiating the indicia with a radio frequency to energize the indicia; and receiving information from the radiated indicia. The information including, but not limited to, an identifier and a value associated with the mailpiece.

In another aspect, the present invention is directed to a postal indicia mailing system. In one embodiment the system comprises a substrate onto which an indicia is to be printed, a printer adapted to print the indicia on the substrate and an electrically conductive fluid used by the printer to form the indicia, the electrically conductive fluid when printed on the substrate forming an electrical circuit that is adapted to passively store information and deliver the information to a receiver when radiated with electrical energy.

In a further aspect the present invention is directed to a proof of purchase system. In one embodiment, the system comprises a substrate onto which an indicia is to be printed, a printer adapted to print the indicia on the substrate and an electrically conductive fluid used by the printer to form the indicia, the electrically conductive fluid when printed on the substrate forming an electrical circuit that is adapted to passively store information and deliver the information to a receiver when radiated with electrical energy.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is an illustration of one embodiment of a mailpiece incorporating features of the present invention.

FIG. 3 is an example of one embodiment incorporating features of the present invention.

FIG. 4 is an example of one embodiment of a scanning/verification system incorporating features of the present invention.

### DETAILED DESCRIPTION OF THE PREFERRED EMBODIMENT(s)

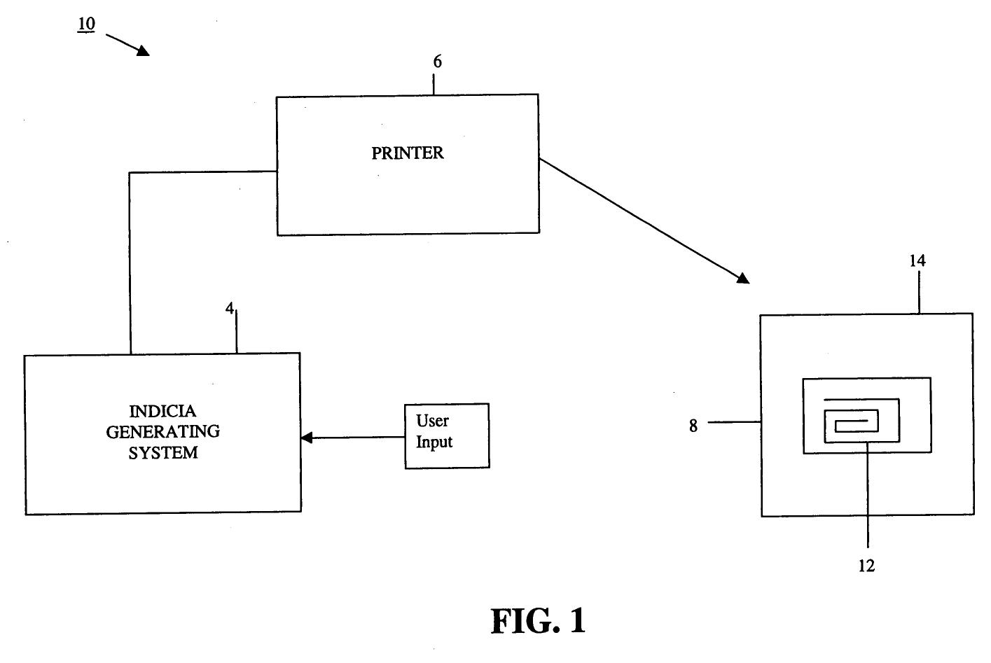

FIG. 1 illustrates one embodiment of a system 10 that is adapted to enable electronic circuits comprising RFID devices to be patterned directly onto a substrate 14, preferably paper or the like. The system 10 generally comprises an indicia generating system 4 and a printing device 6. In alternate embodiments the system 10 could include other suitable components for patterning an electronic circuit onto a substrate. It is a feature of the present invention to print or pattern an RFID circuit, using for example an inkjet printer, directly onto a substrate, such as for example a mailpiece.

Referring to FIG. 1, a perspective view of a system 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

In one embodiment the indicia generating system 4 includes a crypto-vault, such as for example a postal security device, adapted to create and generate digitally signed indicia. Examples of systems and methods of creating and generating indicia are illustrated in U.S. Pat. No. 6,009,417 and U.S. Ser. No. 09/711,741, the disclosures of which are incorporated herein by reference in their entirety. The indicia generating system 4 is adapted to create the indicia and send the indicia to the printer 6 for printing or patterning the indicia 8 on the substrate 14.

The printer or printing device 6 can be any suitable device for forming the indicia 8, including circuit 12, on the substrate 14. In one embodiment, the system 10 is adapted to generate the circuit 12 using for example, an ink jet printer. Using a highly conductive ink, the ink jet printer will deliver the circuit 12 to the substrate 14.

Referring to FIG. 1, a substrate 14 is illustrated that includes an indicia 8 that is formed or patterned as an electronic circuit to comprise a paperbased RFID tag. In one embodiment the indicia 8 comprises an electronic circuit 12 formed for example, by patterning or printing on the substrate 14. The substrate 14 can comprise for example, a mailpiece. In alternate embodiments the substrate 14 could comprise any suitable substrate onto which an electronic circuit can be patterned. These substrates can include for example, materials formed from paper, plastic or cloth.

The electronic circuit 12 is generally formed of a highly conductive ink that is patterned into an electronic circuit adapted to store information. The information can comprise any suitable information such as for example, a unique identifier, an address, a value or a data or other information that may be found in an indicia, or postal indicia. In a postage application, the information could include for example, the information related to originating user and postage meter, a value of the postage associated with the mailpiece, information related to the originating address or postal zone, or information related to the destination address or postal zone. Generally, any information or data that can be converted and stored within the size or storage capabilities of the circuit comprising the RFID can be stored. It is a feature of this invention to cause the ink jet printed image to be formulated as an electronic circuit with a frequency response indicative of the circuit layout such that when the circuit is energized from an external source such as a radio frequency generator, the circuit stores the energy and emits a transmitted energy typified by the ink jet printed circuit on the substrate, such as a mailpiece proof of postage payment indicia. The frequency of the transmitted energy will represent a form of digital ones and zeros, which when collected by the external receiver, will be reformatted into the intended message. The image/circuit signature can then be authenticated and the data is decrypted. In this manner, the information stored in an indicia comprising an RFID patterned circuit can be read.

The chemical composition of the ink delivered by the ink jet to the substrate 14 allows the portion of the substrate 14 being patterned or printed to become leaden with the chemical identity of the ink. For example, the ink jet formulation could comprise a composition of metallic, such as silver or gold at the molecular level, so that when the circuit 12 is energized by an external radio frequency the energy will release the stored information.

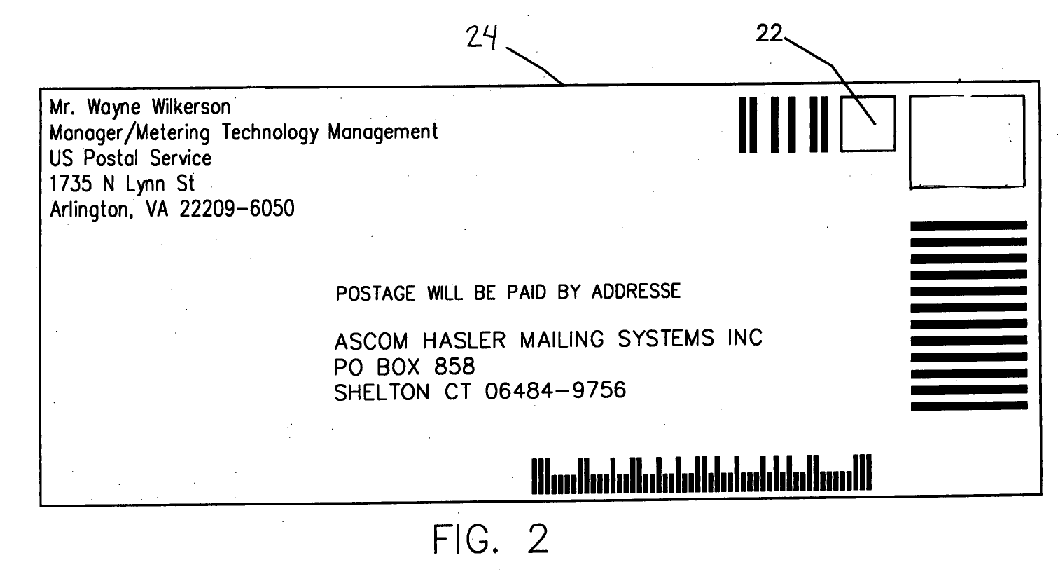

For example, referring to FIG. 2 in one embodiment, the printer 6 prints an indicia 22 comprising an electrical circuit on a mailpiece 24. The design of the circuit is such that a unique identifier including a value of the postage associated with the mailpiece 24 is electronically stored in the circuit. Indicia being printed on a mailpiece for the United States Postal System (“USPS”) must comply with the USPS requirements for Information Based Indicia (“IBI”). The present invention provides for imprinting an IBI indicia circuit pattern on a mailpiece. When the mailpiece 24 is processed in a mail facility the indicia 22 or circuit can be interrogated and the stored information, for example the postage value, or address or other identifier information can be transmitted to the user. For example, the indicia 22 could be scanned by an RFID scanner adapted to radiate the circuit. The energy transmitted by the scanner will be sufficient to power or energize the circuit and allow the stored information, commonly a series of digital ones and zeros to be returned or transmitted back to the scanner. Although the indicia 22, is described as storing identifier information, the memory component of the customized circuit can hold unique information that links the image to an authorized user.

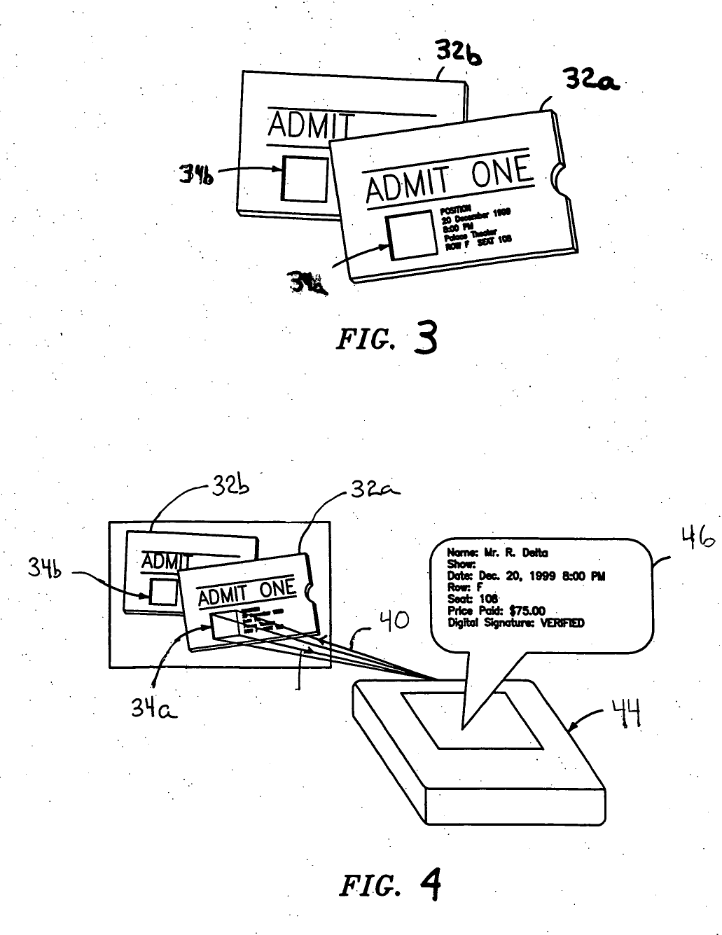

Once the indicia 22 of FIG. 2, comprising a passive electronic circuit or device, is printed on the mailpiece 24, the mailpiece 24 is introduced into the mail system. Although the USPS is generally referred to as the mail system herein, it should be understood that the present invention can be applied to any products that are intended to be one-of-a-type indicia with some value that when presented to a recipient, value is returned. Thus, possible other products and services can include tickets or services that require the presentation of a ticket or printed token such as that shown in FIGS. 3 and 4. In FIG. 3, a pair of tickets 32 are shown each having an indicia portion 34. The indicia portions 34 comprise an RFID tag capable of being printed by an inkjet printer and scanned by an RFID scanning device. The indicia can be scanned at any point during the process to obtain the information stored. For example, a scanning device 44 is shown in FIG. 4 that can be used to energize the indicia 34 on the ticket 32 with an interrogation signal 40 and interpret the signal 42 that is returned. After decoding or demodulation, the data 46 is then available for presentation. In the mail system this could include information about the indicia content.

The data within the indicia or circuit memory could also be encrypted. Public Key Infrastructure (PKI) techniques could be used to encrypt, and/or sign the data within the image's circuit memory so as to prove authenticity of the data and to assure privacy via the encryption.

Although in FIG. 2 the RFID tag or indicia 8 is shown to be formed or patterned directly on the mailpiece, it will be understood that the indicia 8 could be formed on any other medium. In one embodiment, the token or indicia, when printed on the substrate does not have to be visible to the user. For example, the indicia could be printed on a portion of the substrate that is subsequently covered. The RFID indicia could also be printed on a medium that is then covered by a protective covering, for example a plasticized medium. An example of this embodiment could include a envelope that has a clear plastic portion through which an address or other information is visible. This protects the indicia from damage due to handling as well as over copying without damage to the mailpiece. In one embodiment, the indicia could be patterned on the adhesive side of a label that is subsequently adhered to the mailpeiece. In another embodiment where the RFID is formed on a mailpiece, the RFID indicia 8 could also be patterned on the inside, adhesive portions of the mailpiece that are joined together and sealed after the contents are inserted. In this way, the RFID indicia is not only not visible to the user, but is also protected from damage from handling or other sources. The label or portion of the envelope does not prevent the interrogation of the RFID indicia or the transmission of the data and information from the RFID indicia to a reader. In one embodiment, the characteristics of the label or sealing portions of the envelope could be such that if the label is removed from the item to which it is attached or the envelope is opened at the seal, the RFID tag or indicia is damaged to prevent any fraudulent attempts to replicate, alter or duplicate the indicia.

The present invention also provides for the detection of fraudulent copies of printed indicia. Since the ink base that is used to print the indicia 8 of FIG. 1 is highly conductive, if the indicia 8 is copied by for example a photocopier, the quality of the ink on the copy will not be the same as on the original. Reprinting will also not reproduce the RFID indicia in particular, the electronic circuit. The unique characteristics of the electrical circuit need to be known and a digitally reproduced image of the indicia will not reproduce these circuit characteristics. Thus, when comparing the original indicia to the copied indicia using for example a comparing tool, such as a conductivity measuring device, the copy will be identified. The copy will not have the electrical or conductive characteristics that the original has. Furthermore, a copy being scanned by an RFID scanning device will not return any information, thus differentiating the copy from the original indicia.

The present invention also provides two levels of authentication to the IBI indicia pattern. First, a returned energy from the indicia indicates that the indicia being scanned is not a copy. Second, the returned energy (digital ones and zeros) is organized in a bit pattern that can be run through signature and encryption algorithms to prove authenticity. Even if someone were able to reproduce or print an exact copy of the indicia, upon scanning and comparing the scan to a database, the USPS can determine if there is only one such scan in the database. Should it be revealed that there is a second (or duplicate) scan in the database, fraud will be suspected. Since the indicia content identifies the authorized user (via PKI standards of public and private keys and issuing certificate authorities), fraud investigation has a direction to pursue.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method for detecting a value added indicia on a mailpiece comprising:
radiating the indicia with a radio frequency to energize the indicia; and
receiving information from the radiated indicia, the information including an identifier and a value associated with the mailpiece.

2. The method of claim 1 wherein the indicia on the mailpiece is printed on the mailpiece as an electronic circuit that retains information and is adapted to be radiated with energy to energize the circuit and transmit the information to a receiver.

3. The method of claim 1, further comprising after radiating the indicia with energy of, not receiving any information from the radiated indicia and evaluating the indicia to determine if the indicia is a copied indicia.

4. A postal indicia marking system comprising:
a substrate onto which an indicia is to be printed;
a printer adapted to print the indicia on the substrate; and
an electrically conductive fluid used by the printer to form the indicia, the electrically conductive fluid when printed on the substrate forming an electrical circuit that is adapted to passively store information and deliver the information to a receiver when radiated with electrical energy.

5. The system of claim 4 further comprising a scanner adapted to interrogate the indicia as the substrate passes within a range of the scanner, the scanner adapted to verify an authenticity and value of the indicia.

6. The system of claim 4 wherein the substrate includes a protective covering over the indicia.

7. The system of claim 4 wherein the indicia is not visible to a user through the protective covering.

8. The system of claim 4 wherein the indicia is visible to a user through the protective covering.

9. The system of claim 4 wherein the electrically conductive fluid comprises a composition of a metallic at the molecular level that when energized by an external radio frequency releases transmitted information.

10. The system of claim 4 wherein the information stored in the indicia is digitally encrypted.

11. The system of claim 4 wherein the information stored in the indicia is digitally signed.

12. The system of claim 4 wherein the indicia comprises information based indicia.

13. The system of claim 4 wherein the substrate comprises a mailpiece.

14. A proof of purchase system comprising:
a substrate onto which an indicia is to be printed;
a printer adapted to print the indicia on the substrate; and
an electrically conductive fluid used by the printer to form the indicia, the electrically conductive fluid when printed on the substrate forming an electrical circuit that is adapted to passively store information and deliver the information to a receiver when radiated with electrical energy.

15. The system of claim 12, further comprising a scanner adapted to interrogate the indicia as the substrate passes within a range of the scanner, the scanner adapted to verify an authenticity and value of the indicia.

16. The system of claim 14, wherein the substrate includes a protective covering over the indicia.

17. The system of claim 14, wherein the indicia is not visible to a user through the protective covering.

18. The system of claim 14 wherein the indicia is visible to a user through the protective covering.

19. The system of claim 14, wherein the electrically conductive fluid comprises a composition of a metallic at the molecular level that when energized by an external radio frequency releases transmitted information.

20. The system of claim 14, wherein the information stored in the indicia is digitally encrypted.

21. The system of claim 14, wherein the information stored in the indicia is digitally signed.

22. The system of claim 14, wherein the indicia comprises payment information.

23. The system of claim 14, wherein the substrate comprises an admission ticket.

24. The system of claim 14, wherein the substrate comprises a payment voucher.

25. The system of claim 14, wherein the substrate comprises a payment for value to be received.

26. The method of claim 2 wherein the indicia is printed on an adhesive side of a label and the label is adhered to the mail piece, wherein the indicia is not visible to the user.
